(19) United States
(12) Patent Application Publication
(10) Pub. No.: US 2006/0067044 A1
(43) Pub. Date: Mar. 30, 2006

(54) Supporting apparatus for electronic device

(76) Inventors: Mitsuhiro Yoshida, Hanno-shi (JP); Hiroshi Nakamura, Ome-shi (JP); Shinichi Kido, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/236,009

(22) Filed: Sep. 27, 2005

(30) Foreign Application Priority Data
Sep. 29, 2004 (JP) 2004-285221

(51) Int. Cl. G06F 1/16

(52) U.S. Cl. 361/686

(57) ABSTRACT

A supporting apparatus includes a connector, a first hook portion and a second hook portion. The connector is connected to a signal terminal provided at a bottom portion of a portable computer that is chosen from a plurality of electronic devices having different sizes which are dimensions measured from the bottom portions to outer peripheral edges of the portable computes. The first hook portion is provided with respect to the connector in a position corresponding to that of the outer peripheral edge of one of the portable computers. The second hook portion is provided with respect to the connector in a position corresponding to the outer peripheral edge of another of the portable computers.

### CROSS-REFERENCE TO RELATED APPLICATIONS

This application is based upon and claims the benefit of priority from Prior Japanese Patent Application No. 2004-285221, filed Sep. 29, 2004, the entire contents of which are incorporated herein by reference.

### BACKGROUND

1. Field The present invention relates to a supporting apparatus which is provided to connect an external device to an electronic device such as a portable computer, and which allows the electronic device to be detachably engaged with the supporting apparatus.

2. Description of the Related Art

It is important for an electronic device such as a portable computer to be more portable than a conventional electronic device, in order that it has a higher commodity value. In order to further improve the portability of the electronic device, it is considered of its weight, and also of whether it can be more easily held and used at everywhere it will be carried. In view of this point, electronic devices have been made thinner and lighter by separating a section or sections which are low in frequency of use, as an external unit or units, from each electronic device.

Each external unit is connected to the electronic device as occasion arises. Thus, the electronic device also needs to be formed in consideration of whether each external unit is easily connected to the electronic device, and also in consideration of a fact that the sizes and number of connection ports to be formed in an outer portion of the electronic device are limited, since the electronic device is thin as mentioned above. Therefore, there is a case where external units are gathered and a single expansion component is formed. As is often the case with, such an expansion component can be applied to only one electronic device. That is, at present, well-known expansion components cannot be each applied to two or more kinds of portable computers having different sizes.

As a device which can solve the above problem, for example, Jpn. Pat. Appln. KOKAI Publication No. 8-6669 discloses a docking device for a computer. The docking device has connectors to which a number of computers are to be connected, respectively, and also has trays on which each of the computers can be placed. The tray slides between a docking position in which the placed computer is connected to an associated connector of the docking device and an extracted position in which it is disconnected from the connector. Each of the connectors is rotatable between a position in which an associated computer is connected to each connector and a position in which each connector is retreated and located into the docking device.

The docking device disclosed in Jpn. Pat. Appln. KOKAI Publication No. 8-6669 is provided with connection ports for respective computers. In the docking device, while a computer is connected to an associated one of the ports of the docking device, the other port thereof is not used. To be more specific, in order that a computer is connected to an associated port, the other port is rotated to be located in the docking tray, and thus does not interfere with connection of the computer to the associated port. In such a manner, the above docking device has a complicated structure.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing that a docking tray and a docking base of a supporting apparatus according to an embodiment of the present invention are separated from each other.

FIG. 2 is a perspective view showing that the docking tray and the docking base in FIG. 1 are engaged with each other.

FIG. 3 is a perspective view of a rear side of the supporting apparatus shown in FIG. 2.

FIG. 4 is a cross-sectional view of hook portions of the docking tray and a portable computer, which is taken along line F4-F4 in FIG. 2.

### DETAILED DESCRIPTION OF THE EMBODIMENT

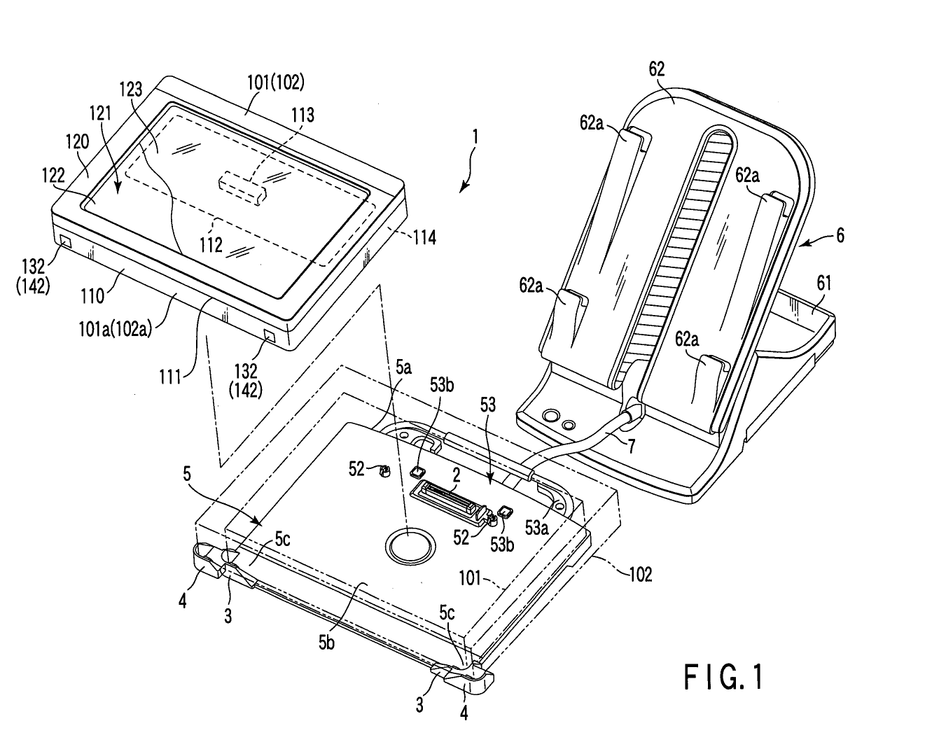

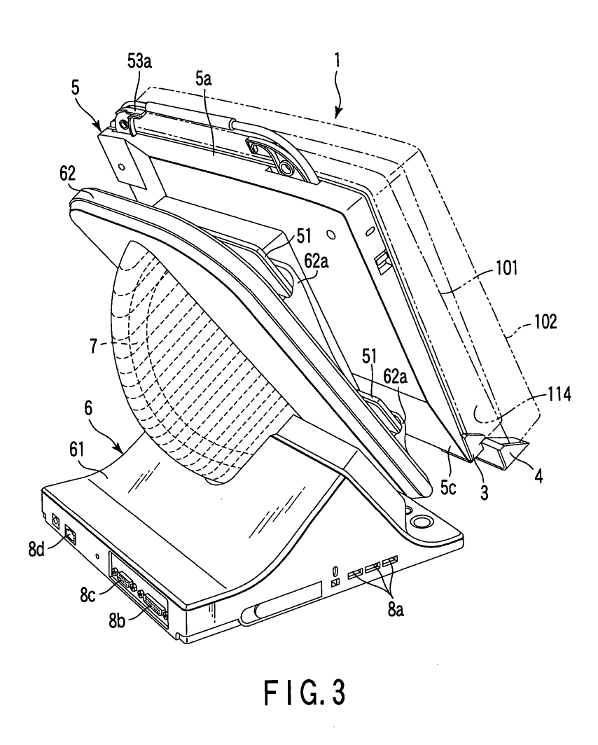

The supporting apparatus according to an embodiment of the present invention will be explained with reference to FIGS. 1 to 4, by referring to a supporting apparatus 1 by way of example, with which each of two kinds of portable computers 101 and 102 having different sizes can be engaged. With respect to the embodiment, as a matter of convenience for explanation, the front, rear, left, right and upper and lower sides of the supporting apparatus 1 are defined as viewed from a user who uses the portable computer 101 or 102 which is engaged with the supporting apparatus 1.

The supporting apparatus 1 shown in FIG. 1 is used to expand the functions of the portable computers 101 and 102. Each of the portable computers 101 and 102 are respective kinds of electronic devices. The portable computers 101 and 102 each comprise a main body 110 and a display unit 120. The main body 110 contains main structural elements such as a CPU and a hard disk driving device. The main body 110 includes a keyboard 112 on an upper surface 111, and a signal terminal 113 for function expansion, which is located at approximately intermediate part of a bottom portion 114 of the main body 110. In the display unit 120, a display device 121 is provided, and a touch panel 123, which is touch sensing type input device, is provided on a display surface 122 of the display device 121. The touch panel 123 is transparent. An inputting operation at the touch panel 123 may be performed by using a specific input pen, while the touch panel 123 synchronizes with an image displayed on the display surface 122.

The display unit 120 is connected to the main body 110 by a hinge mechanism. The display unit 120 is transformed into such that it is in any of an open state, a closed state and a pen input state. In the open state, the display unit 120 is made upright with respect to the main body 110 to expose the keyboard 112. In the closed state, the display unit 120 is laid on the main body 110, with the touch panel 123 facing the keyboard 112. In the pen input state, the display unit 120 is laid on the main body 110, with the touch panel 123 facing a user.

In the case where the state of the display unit 120 is switched from the closed state to the pen input state, the operation will be performed in the following manner. The display unit 120 is made upright to the main body 110. Next, the display unit 120 is turned through 180 degrees around an axis perpendicular to the main body 110. Finally the display unit 120 is laid down on the main body 110, facing a non-display surface side of the display unit 120, which is the reverse side of the touch panel 123 to the keyboard 112.

The supporting apparatus 1, as shown in FIG. 1, comprises a connector 2, first hook portions 3, second hook portions 4, a docking tray 5, a docking base 6 and a cable 7. The connector 2 is located at approximately intermediate part of the docking tray 5, and the first hook portions 3 and the second hook portions 4 are located at corner parts 5c of the docking tray 5. The docking base 6 is set on a flat surface such as the top of a desk, and comprises extension connection terminals 8a, 8b, 8d and 8d, which are provided at side and rear portions of a basal portion 61.

The docking base 6 includes a tray set portion 62 which is inclined from the front side of the basal part 61 to the rearward thereof. The docking tray 5 includes left and right hooking legs 51 which are respectively provided in association with receiving portions 62a provided at the tray set portion 62. The hooking legs 51 are used as legs when the docking tray 5 is placed on a flat surface such as the top of a desk, and are also used as hooking pieces when the docking tray 5 is engaged with the docking base 6.

In the case where an input operation is performed on the potable computers 101 and 102 by using the touch panel 123 engaged with the docking tray 5, the docking tray 5 may be engaged with the docking base 6, or may be placed directly on, e.g., a desk. One of the ends of a cable 7 for communication is connected to the connector 2 provided at the docking tray 5, and the other end is connected to at least the extension connection terminals 8a, 8b, 8d and 8d provided at the docking base 6. The tray set portion 62 can be inclined backwards relative to the basal portion 61, with the docking tray 5 engaged with the tray set portion 62.

Furthermore, the docking base 6 includes a CD-ROM drive unit 63 which is provided at the basal portion 61.

The other end of the cable 7 is also connected to the CD-ROM drive unit 63. Instead of the CD-ROM drive unit 63, a DVD-ROM drive unit or a component drive unit having a function of writing data to a recording medium may be provided. In addition, the docking base 6 may be provided with a socket which allows any other recording medium to be inserted there into.

The docking tray 5 is provided with a lock mechanism 52 and an ejector mechanism 53 which are located close to the connector 2. The lock mechanism 52 locks either the portable computer 101 or 102, whose signal terminal is connected to the connector 2, to prevent the connected portable computer 101 or 102 from dropping off from the docking tray 5. The ejector mechanism 53 comprises a lever 53a and extractors 53b. The lever 53a is provided at an edge 5a of the docking tray 5a. The extractors 53b are located close to the connector 2 at an engagement surface 5b. When being operated, the lever 53a releases the portable computer 101 or 102 from locking of the lock mechanism 52, and push the extractors 53b in a direction in which the portable computer 101 or 102 is separated from the docking tray 5. The portable compute 101 or 102 is ejected from the connector 2 when the extractors 53b are projected.

The connector 2 can be connected to each of signal terminals 113 having the same shape, which are provided at the portable computers 101 and 102 whose sizes are different. In this case, the “sizes” mean dimensions which are measured from the signal terminals 113 to outer peripheral edges 101a and 102a of the portable computers 101 and 102. The connector 2 is inserted into the signal terminal 113 from a bottom portion 114 of the portable computer 101 or 102.

In order that a smaller one of the portable computers 101 and 102, i.e., the portable computer 101, could be set on the docking tray 5, the first hook portions 3 are located in positions corresponding to that of the outer peripheral edge 101a of the portable computer 101. Also, in order that the portable computer 102, which is larger than the portable computer 101 to be set by using the first hook portions 3, could be set on the docking tray 105, the second hook portions 4 are located in positions corresponding to that of the outer peripheral edge 102a of the portable computer 102.

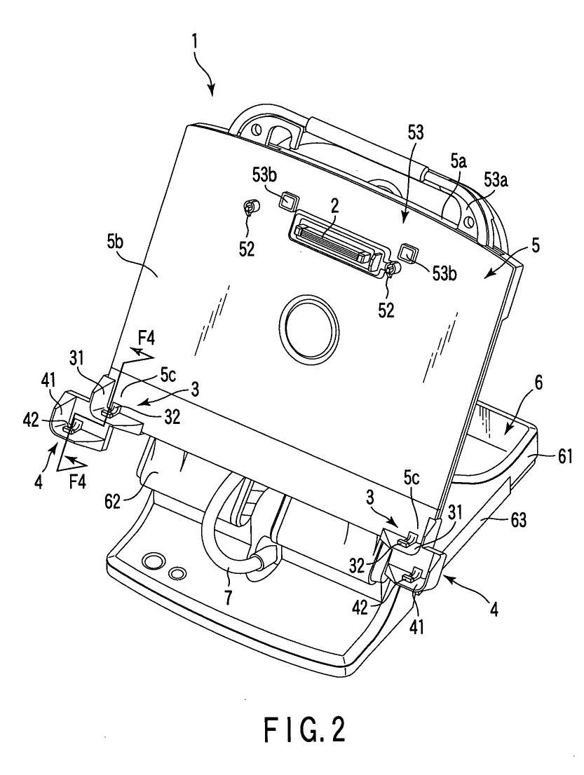

Therefore, as shown in FIGS. 1 and 2, the second hook portions 4 are located farther away from the connector 2 than the first hook portions 3 in a direction crossing a direction in which the signal terminal 113 is ejected from the connector 2, and are also located farther away from the engagement surface 5b of the docking tray 5 than the first hook portions 3 in the direction in which the signal terminal 113 is ejected from the connector 2. In above, the direction crossing the direction in which the signal terminal 113 is ejected from the connector 2 corresponds to a direction along the engagement surface 5b of the docking tray 5. The direction in which the signal terminal 113 is ejected from the connector 2 corresponds to a direction in which the portable computer 101 or 102 is detached from the docking tray 5. Therefore, the distance between the second hook portions 4 is greater than that between the first hook portions 3.

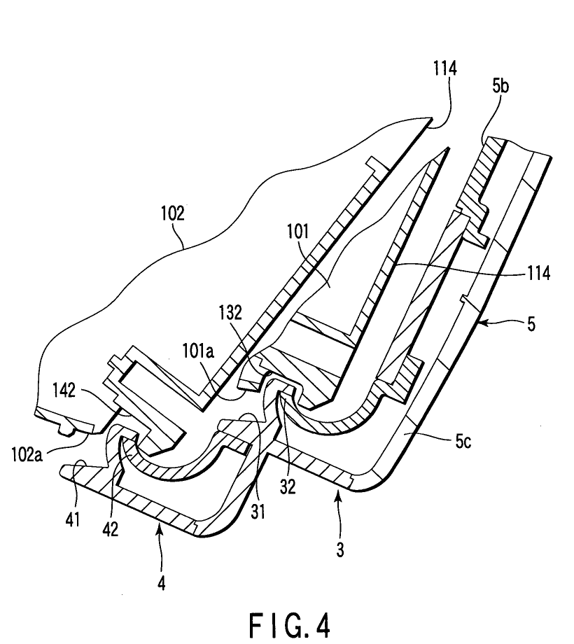

The first hook portions 3 include wall portions 31 each configured to cover a respective corner of the portable computer 101 in two directions, and claws 32 to be engaged with the outer peripheral edge 101a of the portable computer 101. The second hook portions 4 include wall portions 41 each configured to cover a respective corner of the portable computer 102 in two directions, and claws 42 to be engaged with the outer peripheral edge 102a of the portable computer 102. The first hook portion 3 and the second hook portion 4 are provided on part of an edge 5a of the docking tray 5, which is located on the lower side of the docking tray 5 when the docking tray 5 is engaged with the docking base 6. As shown in FIG. 4, in the portable computers 101 and 102, recess portions 132 and 142 are provided in positions corresponding to those of the claws 34 and 42.

The portable computer 101 is hooked by the first hook portions 3, and is then pressed against the docking tray 5, with the first hook portions 3 serving as fulcrums, in order to engage with the docking tray 5. Also, the portable computer 102 is hooked by the second hook portions 4, and is then pressed against the docking tray 5, with the second hook portions 4 serving as fulcrums, in order to engage with the docking tray 5. As the extension connection terminals 8a, 8b, 8d and 8d, e.g., a PS/2 port, a serial port, a parallel port, a USB port, an IEEE-1394 port, a LAN port, an optical communication port, and a telephone line port are provided.

The supporting apparatus 1 having the above structure can be connected to each of the portable computers 101 and 102 having different sizes by the same connector 2. The supporting apparatus 1 does not have a complicated structural member such as an operating section or a driving section, for engaging the portable computer 101 or 102 with the supporting apparatus 1. Its structure is thus simple.

As the portable computers 101 and 102 having different sizes, at least the following computers can be applied: a notebook computer having a display device 121 in which the wideness of a display surface 122 is approximately 12 inches corresponding to so-called B5 size under the Japan Industrial Standards; a notebook computer having a display device 121 in which the wideness of a display surface 122 is 14 inches corresponding to so-called A4 size under the Japan Industrial Standards; a portable digital assistant (PDA); and an electronic equipment having another size. Furthermore, as described above, the supporting apparatus 1 according to the embodiment is allowed to engage with each of two kinds of personal computers 101 and 102. However, as a modification of the embodiment, the supporting apparatus 1 may have a structure for being allowed to engage with each of three or more kinds of portable computers.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A supporting apparatus comprising:
a connector which is to be connected to a signal terminal provided at a bottom portion of a electronic device that is chosen from a plurality of kinds of electronic devices having different sizes which are dimensions measured from the signal terminals to outer peripheral edges of the electronic devices,
a first hook portion which is provided with respect to the connector in a position corresponding to that of the outer peripheral edge of an electronic device that is chosen from the plurality of electronic devices; and
a second hook portion which is provided with respect to the connector in a position corresponding to that of the outer peripheral edge of another electronic device that is chosen from the plurality of electronic devices, said another electronic device has a different size of said the electronic device, said size is dimensions which is measured from said signal terminal to said outer peripheral edge.

2. The supporting apparatus according to claim 1, wherein the connector is to be inserted into the signal terminal from the bottom portion of the electronic device that is chosen from the plurality of electronic devices.

3. The supporting apparatus according to claim 1, wherein the second hook portion is located further away from the connector than the first hook portion in a direction crossing a direction in which the signal terminal is ejected from the connector and distant from the connector than the first hook portion in a direction in which the signal terminal is ejected.

4. The supporting apparatus according to claim 1, wherein associated one of the first hook portion and the second hook portion are provided to hook the outer peripheral edge of the electronic device that is chosen from the plurality of electronic devices, whose signal terminal is connected to the connector, and to hold a motion of the outer peripheral edge in the direction in which the signal terminal is ejected from the connector.

5. The supporting apparatus according to claim 1, which further comprises:
a lock mechanism to be engaged with the electronic device that is chosen from the plurality of electronic devices, whose signal terminal is connected to the connector.

6. The supporting apparatus according to claim 1, which further comprises:
an ejector mechanism for ejecting the electronic device from the connector, whose signal terminal is connected to the connector.

7. The supporting apparatus according to claim 1, which further comprises:
a docking tray on which a main body of the electronic device is to be placed, and
wherein the connector is provided at approximately intermediate part of the docking tray, and the first hook portion and the second hook portion are provided at corner portion of the docking tray.

8. The supporting apparatus according to claim 1, which further comprises:
a docking tray in which the connector is provided at approximately intermediate part of the docking tray, and on which the electronic device is to be placed;
a docking base including a basal portion at which a plurality of extension connection terminals are provided and being engaged with the docking tray; and
a cable which connects the connector and at least the extension connection terminals.

9. The supporting apparatus according to claim 7, wherein:
the first hook portion includes claw to be engaged with the outer peripheral edge of the electronic device; and
the second hook portion includes claw to be engaged with the outer peripheral edge of another electronic device.
